(19) United States
(12) Patent Application Publication
(10) Pub. No.: US 2003/0051767 A1
(43) Pub. Date: Mar. 20, 2003

(54) Package and system

(75) Inventors: Deborah Marie Coccaro, Colonia, NJ (US); Edward John Giblin, Hopatcong, NJ (US); John Michael Paulovich, Hewitt, NJ (US)

Correspondence Address: UNILEVER, PATENT DEPARTMENT, 45 RIVER ROAD, EDGEWATER, NJ, 07020, US

(73) Assignee: Unilever Home and Personal Care USA

(21) Appl. No.: 10/245,947

(22) Filed: Sep. 18, 2002

Related U.S. Application Data
(60) Provisional application No. 60/323,284, filed on Sep. 19, 2001.

(51) Int. Cl. B67C 3/00; B65B 3/00; B65B 1/04

(52) U.S. Cl. 141/351

(57) ABSTRACT

The present invention is directed to a refillable package which is coupled with a sensing or recognition means used to provide or determine information about the past history of the package such as the number of times the package has been refilled. A filling station is also disclosed which has a reading means to cooperate with sensing means on a package and with a filling means in the station.

This application claims the benefit of U.S. provisional application No. 60/323,284 filed Sep. 19, 2001.

### FIELD OF THE INVENTION

The present invention generally relates to a refillable package which is coupled with a sensing or recognition means to provide information about the package, such as its size, and the past history of the package such as the number of times the package has been refilled. In addition, a filling station is disclosed which has an information detector/reading means to cooperate with the sensing means and with a filling means in the station.

### BACKGROUND

Many consumer products are sold in packages such as bottles, bags and boxes. Typically, the consumer purchases the packaged consumer product and discards the bottle, sachet, bag or box, as the case may be, after the consumer product has been used. As can be appreciated, many households generate excessive waste in the form of packages. Moreover, additional waste is generated when such packages are transported in cartons or crates (i.e. secondary packaging) that must be shipped to point of purchase establishments and subsequently discarded.

In addition to waste generation, consumer product packages can be very expensive. In fact, it is well known that a package may cost as much as or more than the consumer product it actually carries. Thus, in order to make acceptable profits, consumer product companies are forced to pass the cost of the packaging onto the consumer.

It is of increasing interest to develop packaging that does not generate excessive waste and does not result in the consumer having to pay additional costs for desired consumer goods.

This invention, therefore, is directed to a package and package system which generates less environmental waste and simultaneously minimizes packaging costs that are typically passed onto the consumer.

For the avoidance of doubt the word “comprising” is intended to mean “including” but not necessarily “consisting of” or “composed of.” In other words, the listed steps or options need not be exhaustive.

### RELATED INFORMATION

Efforts have been disclosed for dispensing a beverage. In U.S. patent application No. 2001/0013524 A1, a beverage server and brewer is described.

Other efforts have been disclosed for dispensing a highly viscous liquid. In U.S. Pat. No. 6,289,837, a rechargeable dispensing system is disclosed.

Still other efforts have been disclosed for dispensing dyestuffs and paints. In U.S. Pat. No. 6,269,978, a dispensing and dosing machine for dyestuffs is disclosed.

None of the information above describes a bottle and bottle system that results in less environmental waste and reduced costs for consumers.

### SUMMARY OF THE INVENTION

In a first aspect, the present invention is directed to a refillable package which is coupled with a sensing or recognition means used to provide information about the package or the past history of the package such as the number of times the package has been refilled.

In a second aspect, the present invention is directed to a filling station which has an information detector/reading means to cooperate with sensing means on a package and with a filling means in the station.

### BRIEF DESCRIPTION OF THE DRAWINGS

The subject matter which is regarded as the invention is particularly pointed out and distinctly claimed in the concluding portion of the specification. The invention, however, may be best understood by reference to the following description taken in conjunction with the accompanying drawing figures in which:

FIG. 1 shows a typical detergent package with a sensing means affixed to the wall of the package.

FIG. 2 shows a typical filling station with a refillable package in place in the filling chamber.

FIG. 3 shows a typical filling station with multiple filling chambers and information detector on top of a product source.

### DETAILED DESCRIPTION OF THE INVENTION

There is no limitation with respect to the consumer product that may be used in the package of the present invention other than that the consumer product is one which is generally made available at a point of purchase establishment. Such consumer products include, but are not limited to, cereals, shampoos, hair conditioners, beverages, creams and ointments, laundry detergents and fabric softeners. In a preferred embodiment, however, the consumer product provided in the package of the present invention is a laundry detergent or a fabric softener.

The form of the consumer product which may be provided in the package of the present invention is limited only to the extent that the consumer product may be refilled in a refillable package. Thus, the consumer product may be in the form of a flake, granule, tablet, powder, paste, slurry or liquid. In a preferred embodiment, however, the consumer product is in the form of a powder or liquid: and most preferably, a liquid.

The package that may be used in this invention is limited only to the extent that it may hold, carry or contain a consumer product, and be refilled. Such a package can be a bottle, bag, sachet or box. In a preferred embodiment, the package is a bottle such as the type that is used to carry a liquid laundry detergent or a liquid fabric softener.

Generally, in order to accomplish the objective of a refillable package and use thereof, a package is provided comprising recognition or sensing means and a filling station, which encompasses a filling unit working in cooperation with the packaging.

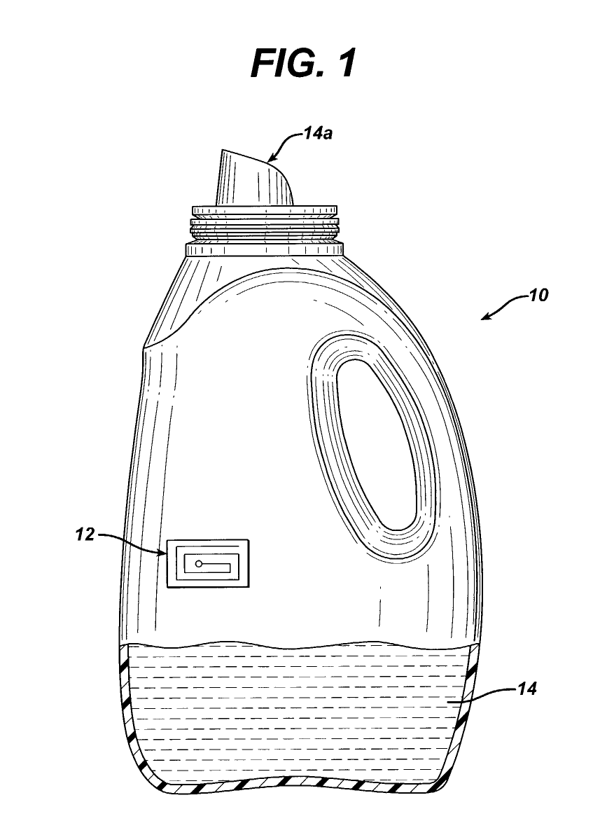

As shown in FIG. 1, an illustrative package 10 (in the form of a bottle) has a sensing means 12 (in the form of a memory chip). The sensing means 12 comprises information about the product 14 (including the volume of product 14 that should go into the package 10 and/or the size of the package 10) and information regarding how many times the package 10 may be refilled with product 14. The information about the product 14 defines or identifies the product 14 as, for example, a laundry detergent, fabric softener or shampoo composition, including any variations thereof. Information regarding how many times the package 10 may be refilled with product 14 means that the package 10 may be refilled a predetermined number of times. The product 14 may be refilled in to the package 10 through opening or spout 14a which is capped with a cap (not shown) when the package 10 is not being refilled and when a consumer is not in need of product 14.

The refillable package comprises a sensing means that provides information in computer readable form via, for example, a bar code label, laser code label, a chip, magnetic strip/resonance, a radio frequency identification transponder (e.g. RF tag) or the like. The recognition or sensing means preferably use radio frequency or magnetism (magnetic resonance) as opposed to a simple bar code, such as currently used on bottles, as they are less likely to be meddled with by the consumer and are more easily capable of uniquely identifying the product unit being used. Additionally, the effectiveness of using radio frequency or magnetism (magnetic resonance) to provide information would not be effected if the package was dirty or obscured in some manner. In addition to or in place of a radio frequency ID tag, a chip may also be used.

There are many different types of sensing means technologies that are currently known in the art that may be used in the present invention. For example, recognition tags currently used for security purposes. Sensormatic and Checkpoint are two such suppliers of these tags. The type of tag to be used could vary between a magnetic or acoustic sensing or radio frequency sensing. There are thus numerous reasonable approaches for the sensing means, such as radio frequency, magnetic resonating and a magnetic tape. The type of sensing means is not critical provided it can accomplish the desired results of recognizing the package as an appropriate package and/or identifying how many times the package has already been refilled and/or how many refills remain. Other information that may be provided by the sensing means is what type of product the package is for (e.g. which fragrance), the amount of product held by the package, the form of the product held in the package or any other information that may be useful for distributing the consumer product.

One of the attributes of the appropriate package will preferably be a flat surface to receive the sensing means. This will more easily enable the actual sensing to be facilitated. However, the package of the present invention is not limited by the shape in any way.

Accordingly, any of the numerous sensing means known in the art may be used in the refillable package of the present invention. The following examples will more fully illustrate, without limitation, the embodiments of the sensing means which are suitable for application to the bottle.

While particular embodiments of the present invention are illustrated and described, it will be obvious to those skilled in the art that various changes and modifications can be made without departing from the spirit and scope of the present invention, and it is intended to cover in the appended claims all such modifications that are within the scope of this invention.

### EXAMPLE 1

One type of sensing means may be the use of a magnetic stripe label. A magnetic stripe label for use on the refillable package of the present invention may comprise a magnetic high coercivity striped label that is applied to the package. The magnetic label may pre-encoded or alternatively, may be encoded at the point of filling. Such coding may be a low density F2F encoding. A low-density reader/encoder containing a single read/write magnetic head may be used. While no limitation is set as to the geometry of system, the head geometry and head pressure system should be such that the reader could easily read labels on the container. Once the magnetic stripe is in position to be read, the reader identifies the container as being correct for refill and then erases the code and rewrites the code with the updated refill value. The updated refill value may indicate for example, the number of refills already used or the number of refills remaining for the package. Additionally, the magnetic label could also have printed on the surface of the label a UPC bar Code which identifies to the checkout lane register at the store that this is a refill status at the register. The high coercivity label and the low-density reader is a preferred embodiment as the use of a high coercivity oxide prevents accidental erasure during the use of the container in a consumer environment.

The magnetic stripe, for example, may have a coercivity of up to 3000 Oerstad. Provision is preferably made to bond the magnetic label on the container so that the surface roughness of the magnetic label is not degraded. However, the abrasion can be avoided by placing a raised wall around the stripe or by debossing the area. Average surface roughness shall not be greater than 1.4 μm. Maximum surface roughness shall not be greater than 8 μm.

### EXAMPLE 2

Another sensing means may be the use of a UPC code. In this embodiment packages that can be refilled contain an extension of the UPC Code when the UPC Code was printed on the package. The extension code contains a series of bars/space at a lower density than the standard UPC code. The extension code indicating how many refills have been done may be decremented using black ink to obliterate the bar/space for that refill. The reader may use either a contact printer (inkpad) to block out the printed decrementing refill unit or a non-contact printer (ink jet). Alternatively, a thermal laser printer may be used to burn out portions of the barcode so as to properly update refill information. Since the standard UPC code is used, the checkout lane register could simply adjust pricing according to how many refills have been used.

### EXAMPLE 3

Another sensing means may be the use of Wiegand wires. In this embodiment, a label is affixed to a package that contains Wiegand wires placed into an appropriate code for limiting the number of refills. The reader is the standard Wiegand reader with the Wiegand magnetic head capturing the code. The refill decrementing is done by changing the status of one or two of the Wiegand Wires in the code using a magnetic current or static magnetic field from a bar magnet. ADT Fire and Security is one such supplier of such technology. As in the high coercivity magnetic stripe label a bar code could be printed on the label that would identify to the check out lane register that this is a refill discount container.

### EXAMPLE 4

Yet another sensing means may be the use of a chip label. This embodiment may comprise the use of a chip that contains information regarding the package, its contents and its refill history. The chip may be a read only chip or a read/write chip. The chip may be active or passive. The chip label may be used in several different embodiments. For instance, a read/write chip label may be used wherein the information on the chip is change by the information detector. For example, the information on the chip may be updated to indicate that the bottle has been refilled an additional time. Another type of chip that can be used is a phone decrementing fusible link chip. In this type of chip label, the chip contains information regarding the package. The information is read by an information detector/reader on a filling station. The information is then sent to a processor that processes the information. The processor may then provide a response to the filling station that the package may be filled. Additionally, the processor may record information about the package such as the fact that it has been refilled, where and when and with what the package has been refilled or any other information that may be useful. A contact type reader may be used with this sensing means. In this embodiment or any other discussed herein, a processor to process information garnered from the sensing means may be located at a sight other than where the filling station is located (i.e. the processor need not be located with the filling station). Such a processor may process data from multiple filling stations. The information may be provided to the processor by any known means of delivering data including, without limitation, telephony, cable, satellite or the like.

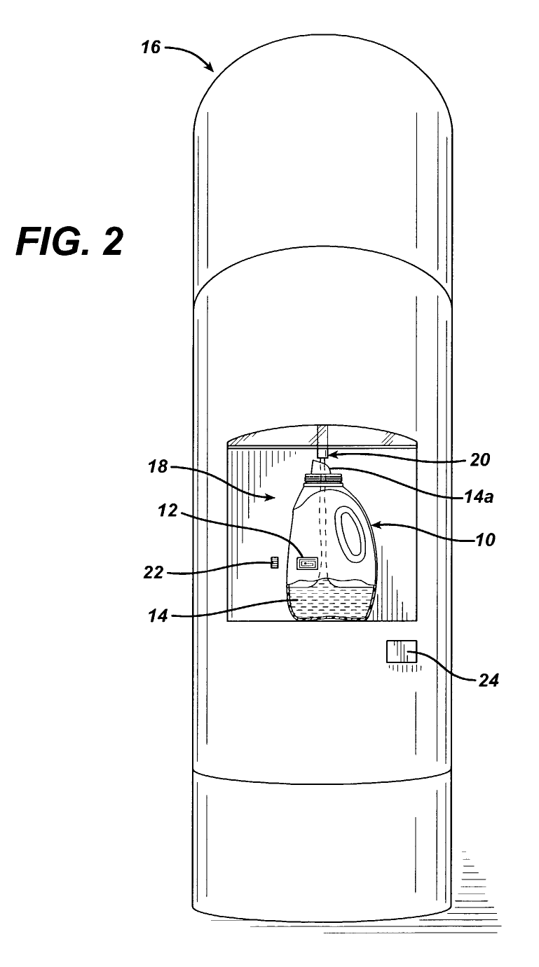

Along with the package comprising sensing means, a dispensing or filling station is also provided to refill the refillable package. Turning to FIG. 2, an illustrative filling station is shown. The filling station 16 (which has a refillable/replaceable product tank, not shown) has a refill space 18 to place or hold package 10 when refilling. Product 14 is fed into package 10 by way of refilling nozzle 20. The type and amount of product 14 being fed into the package 10 is provided to the refilling device 16 by way of information detector 22 which is activated by control panel 24 and which reads the information on sensing means 12. After product 14 is fed into package 10, via opening or spout 14a, the consumer may then take the package 10 and cap it for transport to the venue of use. Information regarding how many times the package 10 has been filled and how many more refills remain is then stored in a computer, not shown, in direct association with the information detector. Alternatively, the information is recorded in the sensing means which provides the information to the information detector the next time the package is provided in the filling station.

It is also noted, that if desired, the refilling device 16 can be modified to not send product ready for use into the package 10 but to send product in the form of concentrate into the package 10 which may be diluted with water by the consumer or by the refilling device 16.

As previously mentioned, refilling device 16 is an illustrative device that may be used for refilling consumer product into a package. It is within the scope of this invention, however, to employ any type of device to refill the package as described herein, as long as the device can detect information on the package to be filled to ensure that it is a proper package and can dispense consumer product.

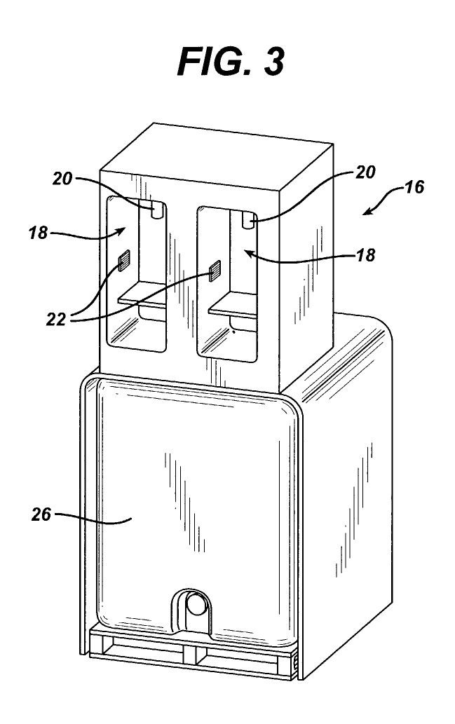

FIG. 3 shows a typical filling station 16 with the filling chamber 18 and information detector 22 located above a product source 26. The product source 26 is the tank(s) that hold(s) the product(s) to be filled into the package to be filled. The tank can be separate from but in connection with the filling station unit so that the tank can simply be replaced once it is low or empty. The unit can simply be disconnected and replaced with a filled tank. Multiple tanks, containing either the same product or a variety of products, may be connected to the filling chamber.

As previously stated, the filling station comprises an information detector (i.e. reader) to garner information from the sensing means of the refillable package. Accordingly, the sensing means must be used in cooperation with the information detector so that the package may be recognized (i.e. is it the correct type of package and does it have refills remaining), refilled and it must also record the remaining refills or numbers of refills on the sensing means. The filling station preferably has a product chamber which holds the product to be filled into the package, a solenoid valve that works in cooperation with the information detector to release product once the information detector has identified the package as being a proper package to be filled, and a timing device to control the amount of product being filled into the package, a display to provide information to the user and for the user to interact with the filling system.

Optionally, a labeler could be included in the filling station which could provide an identification that would allow a cashier in a store to scan the package and charge the customer the appropriate amount. This would also enable the store or a processor monitoring the system from off sight to know when the filling station product container needs to refilled.

An example of an information detector and its use and operation is described below. This information detector may be used with a magnetic stripe sensing means embodiment.

The information detector described below may be a simple reading device (reader) to read the information on the magnetic stripe label. Alternatively, a read/write information detector may be used. The power for the reader will preferably come from a “pull” stroke of a tubular solenoid. This will load the Air port piston prior to the read/write cycle. A start command (from a Kiosk) will release the solenoid and the Air port and the spring will provide both jitter free motion and drive the magnetic head over the media surface. The self-locking decoder will retrieve the stored data. These types of information detector are well known in the art. The information detector in the fill station could be, for example, one design by ELK Technologies of Reagan Street, Sunbury, Pa.

Any type of information detector (i.e. reader) known in the art may be used as long as it provides the means to read the information from the sensing means on the package. One level of encoding considered appropriate for use in the present invention is outlined as follows.

The message is written on a single track.

The message length is eight bits (one byte) at approximately 50 BPI.

The read/write speed is 5 to 15 inches per second.

The data is written as Aikin two phases coherent.

The initial value may be applied to the package in numerous ways. The initial value may be applied as an erased tape with no magnetic data, or a prerecorded tape with a field authorizing the specified number of refills.

In the first case when the initial value is applied as an erased tape with no magnetic data, at the first request to refill, the information detector will seek the blank magnetic media and will write it with one decrement. If no media is detected, the refill will not be authorized. This is attractive because there is no need to pre-record data on the media when it is applied to each new package. But it means that the dispenser must assign an initial value. This offers no security in identifying packages from any authorized source.

The second case requires the tape to be pre-recorded or to be encoded in place on the package prior to its sale. This offers complete security and identification on the source of the container.

No matter which way the initial value is placed on the package sensing means, the refill sequence is the same thereafter. Each time a package is loaded for refilling the information detector will scan that data and authorize the refill. Once the vending machine confirms the refill, the information detector will erase all existing data and rewrite a new value for the remaining number of refills. When no authorizing value remains the refill will be denied. This form of rewriting the data is advantageous because it guarantees the data is refreshed at each refill and there are no partial data fields, or complex rewrite zones, that must be recognized by the information detector.

The major elements of an information detector for use in a magnetic stripe label embodiment will typically be a combination read/write head mounted on a cantilevered arm, a precision air damping dashpot, and a turbular DC solenoid, with a spring return.

In operation, the consumer will insert an empty package (with cap off) in the designated place in the unit. They will then push a “button” that could indicate the fragrance type or variant of product or other attributes desired (regular/original, lemon, etc.) the fill will then automatically commence with the appropriate variant and attribute added during the fill cycle. The bulk detergent or other product preferably will not contain any fragrance. It is added during the fill. The package is automatically filled to the correct level—quart, half-gallon, gallon. The unit will automatically sense the size package and fill accordingly. Additionally, U.S. patent application Ser. No. 09/955,894 deals with the method of using the above mentioned package and system, the disclosure of which is incorporated herein by reference.

The filling station may have a pump system to transfer product from the product source into filling station and into the package. The package filling station also may have automatic level fill, “fail safe” cutoff with backup system, automatic cap feed, place, tighten or torque, and/or, fragrance or other attribute or other product variant dispensing system.

It should be understood, of course, that the specific forms of the invention herein illustrated and described are intended to be representative only, as certain changes may be made therein without departing from the clear teachings of the disclosure. Accordingly, reference should be made to the following appended claims in determining the full scope of the invention.

We claim:

1. A package suitable for storing consumer products comprising a sensing means, said sensing means being responsive to an outside reader capable of interpreting and/or updating data stored on the sensing means.

2. A package according to claim 1 wherein said sensing means is a magnetic stripe label.

3. A package according to claim 1 wherein said sensing means is a UPC code.

4. A package according to claim 1 wherein said sensing means is Wiegand wires.

5. A package according to claim 1 wherein said sensing means is a memory chip.

6. A package according to claim 1 wherein said consumer product is a liquid laundry detergent.

7. A package according to claim 1 wherein said package is a plastic laundry detergent bottle.

8. A filling station for refilling a package suitable for use in storing consumer product comprising a housing having a filling chamber, a product source connected to said filling chamber by means of a valve, a reader mounted in said housing being responsive to a sensing means said sensing means being mounted on a refillable container, means on said housing responsive to said sensing means to cause liquid product to enter said filling chamber through, said valves.
